(19) United States
(12) Patent Application Publication
(10) Pub. No.: US 2026/0104697 A1
(43) Pub. Date: Apr. 16, 2026

(54) RECOMMENDATION SYSTEM AND METHOD FOR CUTTER AND COATING COMBINATION BASED ON WORKPIECE PARAMETERS

(71) Applicant: Harbin University of Science and Technology, Harbin City (CN)

(72) Inventors: Caixu YUE, Harbin City (CN); Zhipeng JIANG, Harbin City (CN); Qiang LIU, Harbin City (CN); Haotuo LIU, Harbin City (CN); Boyang MENG, Harbin City (CN); Wei XIA, Harbin City (CN); Xianli LIU, Harbin City (CN); Fugang YAN, Harbin City (CN)

(73) Assignee: Harbin University of Science and Technology, Harbin City, HL (CN)

(21) Appl. No.: 19/418,983

(22) Filed: Dec. 13, 2025

(30) Foreign Application Priority Data
Apr. 3, 2025 (CN) 202510418799.4

(51) Int. Cl. G05B 19/418

(52) U.S. Cl. CPC G05B 19/41885; G05B 19/41875

(57) ABSTRACT

Recommendation system and method for cutter and coating combination based on workpiece parameters are provided. The system comprises: an experiment module, configured for collecting machining performance data including cutter characteristic data and cutting performance data of workpiece; a prediction-model-establishment module, configured for establishing a performance-prediction model; a simulation module, configured for randomly combining parameters to generate individuals in an initial population, and inputting the individuals into the trained performance-prediction model to obtain data; a data-processing module, configured for processing the data to obtain a life-evaluation coefficient, a quality-evaluation coefficient, and a comprehensive evaluation coefficient; an iterative optimization module, configured for iteratively optimizing the initial population through a genetic algorithm based on minimization of the comprehensive evaluation coefficient; and extracting an optimal value of cutter parameters and an optimal value of coating parameters; and a recommendation module, configured for selecting an optimal combination and recommending to a user.

### CROSS-REFERENCE TO RELATED APPLICATION

This application claims priority to Chinese Patent Application No. 202510418799.4, filed on Apr. 3, 2025, which is hereby incorporated by reference in its entirety.

### TECHNICAL FIELD

The present disclosure relates to the technical field of cutter and coating combination, specifically to a recommendation system and method for cutter and coating combination based on workpiece parameters.

### BACKGROUND ART

With the development of advanced manufacturing technology and high-performance materials, coating technology and structure of cutter have made significant progress. The combination of cutting edge and coating plays a key role in mechanical processing, directly affecting life of the cutter and processing quality. For example, the micro-arc-shaped structure on the cutting edge can reduce the cutting resistance of high-strength steel and enhance coating adhesion. The TiAlN coating has good high-temperature stability, which can maintain good wear resistance of the cutter during milling heat generation. The combination of micro-arc-shaped cutting edge and TiAlN coating can reduce cutting heat, extend life of the cutter, and improve production efficiency. Moreover, the cutter has stable performance and high cutting quality in high temperature and high stress environments.

The existing technology lacks scientific and effective methods for selecting the combination of cutting edge structures and coatings, often relying on a large number of tedious actual tests and repeated adjustments. This not only takes time and effort, but also makes it difficult to ensure that the best matching solution can be found every time. Due to this unreasonable selection, the cutter exposes serious technical defects during the machining process.

The above information disclosed in this section is only for enhancing the understanding of the background of the present disclosure, and therefore it may include information that does not constitute prior art known to a person of ordinary skill in the art.

### SUMMARY

The purpose of the present disclosure is to provide recommendation system and method for cutter and coating combination based on workpiece parameters, in order to solve the problems proposed in the background art mentioned above.

To achieve the above objectives, the present disclosure provides the following technical solution:

A recommendation system for cutter and coating combination based on workpiece parameters, including:
an experiment module, configured for, under different combinations of cutter parameters and coating parameters, conducting machining experiments on a workpiece to be machined with known workpiece parameters to determine machining performance data corresponding to each of the different combinations; where the machining performance data includes: cutting performance data of workpiece and cutter characteristic data;
a prediction-model-establishment module, configured for establishing a performance-prediction model; where combinations of cutter parameters and coating parameters, and the known workpiece parameters of the workpiece to be machined are served as input features of the performance-prediction model, and the workpiece cutting performance data and the cutter characteristic data are served as output labels of the performance-prediction model, and the performance-prediction model is trained;
a simulation module, configured for randomly combining the cutter parameters and the coating parameters, establishing individuals in an initial population, and inputting the individuals in the initial population and the known workpiece parameters of the workpiece to be machined into the trained performance-prediction model, to obtain the workpiece cutting performance data and the cutter characteristic data;
a data-processing module, configured for processing the cutter characteristic data to obtain a life-evaluation coefficient for evaluating life of a cutter; and processing the workpiece cutting performance data to obtain a quality-evaluation coefficient for evaluating quality of a workpiece; and linearly processing the life-evaluation coefficient and the quality-evaluation coefficient to obtain a comprehensive evaluation coefficient;
an iterative optimization module, configured for iteratively optimizing the individuals in the initial population through a genetic algorithm based on minimization of the comprehensive evaluation coefficient, to obtain optimal individuals; and extracting an optimal value of the cutter parameters and an optimal value of the coating parameters based on the optimal individuals; and
a recommendation module, configured for selecting an optimal combination of a cutter with an optimal value and a coating with an optimal value and recommending to a user.

In some embodiments, the known workpiece parameters include a material type of workpiece, which includes: mild steel, medium carbon steel, high carbon steel, stainless steel, aluminum alloy, copper alloy, titanium alloy, nickel-based alloy, plastic, ceramic, and composites; and the cutter parameters include: a material type of cutter and a form type of cutting edge; the material type of cutter includes: high-speed steel, cemented carbide, ceramic material, cubic boron nitride, and polycrystalline diamond; and the form type of cutting edge includes: straight edge, arc-shaped edge, cutting edge with negative chamber, tooth-shaped edge, and cutting edge with micro rounded corner; and the coating parameters include: a material type of coating and a thickness of coating; where the material type of coating includes: titanium nitride, titanium carbonitride, aluminum titanium nitride, chromium nitride, and diamond coating.

In some embodiments, the cutter characteristic data includes: a wear width of rear cutting edge and in increase in cutting force; and the workpiece cutting performance data includes: surface roughness and residual stress of the workpiece.

In some embodiments, a material set W of the workpiece is defined, where W={Wᵢ|i∈[1, n]}; and Wᵢ represents a material type of an i-th type of workpiece, i represents an index of the material type of workpiece, and n represents a number of material types of workpiece;
where a process of randomly combining the cutter parameters and the coating parameters, and establishing individuals in the initial population includes:
defining a material set of cutter as T, where T={T_{α}|α∈[1, m]}; T_{α} represents a material type of an α-th type of cutter, α represents an index of the material type of cutter, and m represents a number of material types of cutter;
defining a form set of cutting edge as R, where R={Rβ|β∈[1, r]}; R_{β} represents a form of a β-th type of cutting edge, β represents an index of the form of cutting edge, and r represents a number of forms of cutting edge;
defining a material set of coating as C, where C={C_{γ}|γ∈[1, k]}; C_{γ} represents a material type of a γ-th type of coating, γ represents an index of the material type of coating, and k represents a number of material types of coating;
defining a thickness set of coating as H, where H={H_{ρ}|ρ∈[1, g]}; H_{ρ} represents a thickness of a ρ-th type of coating, ρ represents an index of the thickness of coating, and g represents a number of thicknesses of coating;
defining the initial population as Q, and where Q={Q₁, Q₂, . . . , Qⱼ . . . , Qₙ}; Qⱼ represents a j-th individual in the initial population, j represents an index of an individual in the initial population, and j∈[1, d], d represents a number of individuals in the initial population; and Qⱼ={T_{αj}, R_{βj}, C_{γj}, H_{ρj}}; where T_{αj}, R_{βj}, C_{γj}, and H_{ρj} represent a material type of cutter, a form type of cutting edge, a material type of coating, and a thickness of coating of the j-th individual, respectively.

In some embodiments, the cutter characteristic data is processed based on following formula to obtain the life-evaluation coefficient for evaluating life of the cutter:

$${SPxs}_{j} = {w}_{1} {Vb}_{j} + {w}_{2} Δ {F}_{j} ;$$

where SPxsⱼ represents a life-evaluation coefficient of the j-th individual, and the life-evaluation coefficient is used to comprehensively evaluate a length of life of the cutter by combining two indicators of the wear width of rear cutting edge and the increase in cutting force; Vbⱼ represents the wear width of rear cutting edge of the j-th individual; ΔFⱼ represents the increase in cutting force of the j-th individual; and j represents the index of the individual in the initial population;
and where w₁ represents a weight coefficient of the wear width of rear cutting edge, and w₂ represents a weight coefficient of the increase in cutting force; and where when w₁+w₂=1 is met, 0<w₂<w₁<1.

In some embodiments, the cutting performance data is processed based on following formula to obtain the quality-evaluation coefficient for evaluating quality of the workpiece:

$${QPxs}_{j} = {w}_{3} {Ra}_{j} + {w}_{4} {σ}_{j} ;$$

where QPxsⱼ represents a quality-evaluation coefficient of the j-th individual, and the quality-evaluation coefficient is used to comprehensively evaluate a quality of the workpiece by combining two indicators of the surface roughness and the residual stress of the workpiece; Raⱼ represents the surface roughness of the workpiece of the j-th individual; and σⱼ represents the residual stress of the j-th individual;
and where w₃ represents a weight coefficient of the surface roughness of workpiece, and w₄ represents a weight coefficient of the residual stress; and where when w₃+w₄=1 is met, 0<w₄<w₃<1.

In some embodiments, the life-evaluation coefficient and the quality-evaluation coefficient are processed based on following formula to obtain the comprehensive evaluation coefficient:

$${ZPxs}_{j} = {w}_{5} {SPxs}_{j} + {w}_{6} {QPxs}_{j} ;$$

where ZPxsⱼ represents a comprehensive evaluation coefficient of the j-th individual, and the comprehensive evaluation coefficient is used to comprehensively evaluate an overall performance of the combination of cutter and coating by combining two indicators of the life-evaluation coefficient and the quality-evaluation coefficient;
and where w₅ represents a weight coefficient of the life-evaluation coefficient, and w₆ represents a weight coefficient of the quality-evaluation coefficient; and values of w₅ and w₆ are determined by an analytic hierarchy process.

In some embodiments, the iteratively optimizing the individuals in the initial population through a genetic algorithm based on minimization of the comprehensive evaluation coefficients, to obtain optimal individuals; and extracting an optimal value of the cutter parameters and an optimal value of the coating parameters based on the optimal individuals include:
serving a minimization of the comprehensive evaluation coefficient ZPxsⱼ as an optimization objective, and iteratively optimizing the initial population Q, which includes: selecting individuals in the initial population Q and performing cross-operation on the selected individuals; where during the iteratively optimizing, constraint conditions including a maximum value and a minimum value of the thickness of coating are preset; and within a constraint range of the thickness of coating, iteratively optimizing the initial population Q, which includes: sorting all comprehensive evaluation coefficients ZPxsⱼ corresponding to the individuals in an ascending order to obtain a sequence, selecting individuals corresponding to a top 50% of the sequence as parents, exchanging genes of individuals in the parents through the cross-operation and combining to obtain new individuals, and repeating a process of selecting individuals corresponding to a top 50% of the sequence as parents, exchanging genes of individuals in the parents through the cross-operation and combining to obtain new individuals, until a predetermined number of iterations is reached;
after iteratively optimizing the initial population Q, serving the optimal individuals as Qⱼ₁={T_{α1j1}, R_{β1j1}, C_{γ1j1}, H_{ρ1j1}}; and the optimal value of the cutter parameters and the optimal value of the coating parameters include: a material type of cutter T_{α1j1}, a form type of cutting edge R_{β1j1}, a material type of coating C_{γ1j1}, and a thickness of coating H_{ρ1j1}, respectively.

In order to achieve the above objective, the present disclosure also provides following technical solution:

A recommendation method for cutting and coating combination based on workpiece parameters is provided, which is generated based on the above recommendation system, and the recommendation method includes following steps:
step S1: under combinations of cutter parameters and coating parameters, conducting machining experiments on a workpiece to be machined with known workpiece parameters to determine machining performance data corresponding to each of the combinations; where the machining performance data includes: workpiece cutting performance data to be processed and cutter characteristic data;
step S2: establishing a performance-prediction model; where combinations of cutter parameters and coating parameters, and the known workpiece parameters of the workpiece to be machined are served as input features of the performance-prediction model, and the workpiece cutting performance data and the cutter characteristic data are served as output labels of the performance-prediction model, and the performance-prediction model is trained;
step S3: randomly combining the cutter parameters and the coating parameters, establishing individuals in an initial population, and inputting the individuals in the initial population and the known workpiece parameters of the workpiece to be machined into the trained performance-prediction model, to obtain the workpiece cutting performance data and the cutter characteristic data;
step S4: processing the cutter characteristic data to obtain a life-evaluation coefficient for evaluating life of a cutter; and processing the workpiece cutting performance data to obtain a quality-evaluation coefficient for evaluating quality of a workpiece; and linearly processing the life-evaluation coefficients and the quality-evaluation coefficients to obtain a comprehensive evaluation coefficient;
step S5: iteratively optimizing the individuals in the initial population through a genetic algorithm based on minimization of the comprehensive evaluation coefficient, to obtain optimal individuals; and extracting an optimal value of the cutter parameters and an optimal value of the coating parameters based on the optimal individuals; and
step S6: selecting an optimal combination of a cutter with an optimal value and a coating with an optimal value and recommending to a user.

Compared with the existing technology, beneficial effects of the present disclosure are as follows:

In the present disclosure, the experiment module collects machining performance data under different parameter combinations; the prediction-model-establishment module trains the model that can accurately analyze the relationship between parameter and performance based on the machining performance data; the simulation module randomly combines parameters to obtain individuals, and inputs the model to obtain the machining performance data; the data-processing module generates the life-evaluation coefficient, the quality-evaluation coefficient, and the comprehensive evaluation coefficient; the iterative optimization module optimizes the individuals through the genetic algorithm based on minimization of the comprehensive evaluation coefficient, to obtain the optimal value of the cutter parameters and the optimal value of the coating parameters, and the recommendation module provides the optimal combination. The entire process forms a scientific and efficient closed loop, greatly reducing the number of actual tests, quickly and accurately finding the best matching solution for cutter and coating that can extend life of cutter, reduce machining costs, improve machining quality, and is suitable for different machining scenarios, solving shortcomings of the existing technology.

### BRIEF DESCRIPTION OF THE DRAWINGS

FIG. 1 shows a block diagram of the module composition according to the present disclosure.

FIG. 2 shows a schematic diagram of the process of the overall method according to the present disclosure.

### DETAILED DESCRIPTION OF THE EMBODIMENTS

In order to clarify the purpose, technical solution, and advantages of the present disclosure, the present disclosure will be further described in detail with specific embodiments.

It should be noted that, unless otherwise defined, the technical or scientific terms used in the present disclosure should have the usual meanings understood by those with general skills in the field to which the present disclosure belongs. The terms “first”, “second”, and similar words used in the present disclosure do not indicate any order, quantity, or importance, but are only used to distinguish different components. The words such as “including” or “containing” refer to elements or objects that appear before the words include elements or objects and equivalents thereof listed after the words, without excluding other elements or objects. The words such as “connection” or “link” are not limited to physical or mechanical connections, but can include electrical connections, whether direct or indirect. The “up”, “down”, “left”, “right”, etc. are only used to represent relative positional relationships. When the absolute position of the described object changes, the relative positional relationship may also be changed accordingly.

### Embodiment 1

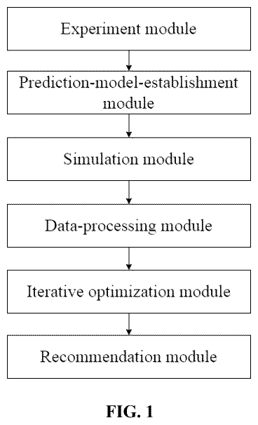

Please refer to FIG. 1, the present disclosure provides a technical solution:

A recommendation system for cutter and coating combination based on workpiece parameters is provided, which includes: an experiment module, a prediction-model-establishment module, a simulation module, a data-processing module, an iterative optimization module, and a recommendation module.

The experiment module is configured for, under combinations of cutter parameters and coating parameters, conducting machining experiments on a workpiece to be machined with known workpiece parameters to determine machining performance data corresponding to each of the combinations. The machining performance data includes: cutting performance data of workpiece and cutter characteristic data.

Based on the above embodiment, the workpiece parameters include a material type of workpiece. The material type of workpiece includes: mild steel, medium carbon steel, high carbon steel, stainless steel, aluminum alloy, copper alloy, titanium alloy, nickel-based alloy, plastic, ceramic, and composites. The cutter parameters include: a material type of cutter and a form type of cutting edge. The material type of cutter includes: high-speed steel, cemented carbide, ceramic material, cubic boron nitride, and polycrystalline diamond. The form type of cutting edge includes: straight edge, arc-shaped edge, cutting edge with negative chamber, tooth-shaped edge, and cutting edge with micro rounded corner. The coating parameters include: a material type of coating and a thickness of coating. The material type of of coating includes: titanium nitride, titanium carbonitride, aluminum titanium nitride, chromium nitride, and diamond coating.

The mild steel, medium carbon steel, high carbon steel, stainless steel, aluminum alloy, copper alloy, titanium alloy, nickel-based alloy, plastic, ceramic, and composites are assigned values of 01, 02, 03, 04, 05, 06, 07, 08, 09, 10, and 11 in sequence.

The high-speed steel, cemented carbide, ceramic material, cubic boron nitride, and polycrystalline diamond are assigned values of 01, 02, 03, 04, and 05 in sequence.

The straight edge, arc-shaped edge, cutting edge with negative chamber, tooth-shaped edge, and cutting edge with micro rounded corner are assigned values of 01, 02, 03, 04, and 05 in sequence.

The titanium nitride, titanium carbonitride, aluminum titanium nitride, chromium nitride, and diamond coating are assigned values of 01, 02, 03, 04, and 05 in sequence.

Based on the above embodiment, the cutter characteristic data includes: a wear width of rear cutting edge and increase in cutting force. The workpiece cutting performance data includes: surface roughness and residual stress of the workpiece.

Based on the above embodiment, the methods for collecting the wear width of rear cutting edge, the increase in cutting force, the surface roughness of workpiece, and the residual stress are as follows:

Before the workpiece is machined, a tool microscope is used to measure the initial wear width of rear cutting edge. After the workpiece is machined by the cutter, the cutter is disassembled from the machine tool, and is placed on the workbench of the measuring instrument. The rear cutting edge of the cutter is observed through lens of the microscope or the projector, and the final wear width of rear cutting edge is measured. The initial wear width of rear cutting edge is subtracted from the final wear width of rear cutting edge to obtain the wear width of rear cutting edge.

A piezoelectric force gauge is installed on the spindle of the machine tool. The cutting force at the moment when the cutter has just cut into the workpiece and the cutting process has not yet entered a stable state is collected as the initial value of the cutting force. During the machining process of the workpiece, data of cutting force is collected every 10 minutes. The data collection system is used to convert the force signal into a digital signal and the digital signal is recorded. Based on the initial value of the cutting force and the cutting force at different moments, the absolute value of the variation between the cutting force at the next moment and the cutting force at the previous moment is calculated. Then the ratio of the absolute value of the variation between the cutting forces at adjacent moments to the initial value of the cutting force is calculated to obtain the increase in cutting force.

After the machining process is completed, a surface-roughness measuring instrument with a diamond probe is used. The probe is placed on the cutting surface of the workpiece to be machined, and the probe is slowly moved along the measured surface. The probe will move up and down with the micro undulations of the surface. This movement is converted into an electrical signal by a sensor, and then amplified by an amplifier and processed by a data processing system to finally obtain the numerical value of surface roughness of the workpiece.

And after the machining process is completed, X-ray is used to irradiate the surface of the workpiece. When the X-ray is incident in the crystal material, diffraction phenomenon occurs. Due to the existence of residual stress, the crystal lattice will be distorted, resulting in change in diffraction angle. By measuring the change in diffraction angle, the residual stress on the surface of the workpiece can be calculated based on the relevant stress-strain relationship formula.

The collected wear width of rear cutting edge, the increase in cutting force, the surface roughness of workpiece, and the residual stress need to be normalized. Through normalization, the data of different indicators are unified into the range of 0 to 1, eliminating the influence of dimensionality and value range, making these data comparable and consistent in subsequent analysis and operations.

The prediction-model-establishment module is configured for establishing a performance-prediction model. Combinations of workpiece parameters, cutter parameters, and coating parameters are served as input features of the performance-prediction model, and the cutting performance data and the cutter characteristic data are served as output labels of the performance-prediction model, and the performance-prediction model is trained.

Based on the above embodiment, the performance-prediction model adopts a deep learning network based on multiple layers of perceptron. The deep learning network based on multiple layers of perceptron includes: an input layer, a first hidden layer, a second hidden layer, a third hidden layer, and an output layer. The first hidden layer, the second hidden layer, and the third hidden layer all have at least two neurons and use ReLU as the activation function.

In the performance-prediction model, the input features of the deep learning network based on multiple layers of perceptron include: the combination of cutter parameters and coating parameters, and the parameters of the workpiece to be processed, and there are three sets of features.

The deep learning network based on multiple layers of perceptron includes following structures:
the input layer, which receives the three sets of features;
the first hidden layer, which has 128 neurons and uses ReLU as the activation function;
the second hidden layer, which has 64 neurons and uses ReLU as the activation function;
the third hidden layer, which has 32 neurons and uses ReLU as the activation function;
the output layer: which has 2 neurons and outputs the cutter characteristic data and the workpiece performance data.

The process of training the performance-prediction model is as follows:

Combinations of cutter parameters and coating parameters, and the workpiece parameters of the workpiece to be machined are served as the input of the performance-prediction model, and the workpiece cutting performance data and the cutter characteristic data are served as the output labels of the performance-prediction model, and the performance-prediction model can be trained. The mean square error is served as the loss function. When the mean square error is within the range of [0, 0.01], the training of the performance-prediction model is completed.

The simulation module is configured for randomly combining the cutter parameters and the coating parameters, establishing individuals in an initial population, and inputting the individuals in the initial population and the known workpiece parameters of the workpiece to be machined into the trained performance-prediction model, to obtain the workpiece cutting performance data and the cutter characteristic data.

Based on the above embodiment, a material set W of the workpiece is defined, and W={Wᵢ|i∈[1, n]}. Wᵢ represents a material type of an i-th type of workpiece, i represents an index of the material type of workpiece, and n represents a number of material types of workpiece.

A process of randomly combining the cutter parameters and the coating parameters, and establishing individuals in the initial population is as follows:

A material set of cutter is defined as T, and T={T_{α}|α∈[1, m]}. T_{α} represents a material type of an α-th type of cutter, α represents an index of the material type of cutter, and m represents a number of material types of cutter.

A form set of cutting edge is defined as R, and R={R_{β}|β∈[1, r]}. Ra represents a form of a β-th type of cutting edge, β represents an index of the form of cutting edge, and r represents a number of forms of cutting edge.

A material set of coating is defined as C, and C={C_{γ}|γ∈[1, k]}. C_{γ} represents a material type of a γ-th type of coating, γ represents an index of the material type of coating, and k represents a number of material types of coating.

A thickness set of coating is defined as H, and H={H_{ρ}|ρ∈[1, g]}. H_{ρ} represents a thickness of a ρ-th type of coating, ρ represents an index of the thickness of coating, and g represents a number of thicknesses of coating.

The initial population is defined as Q, and Q={Q₁, Q₂, . . . , Qⱼ . . . , Qₙ}. Qⱼ represents a j-th individual in the initial population, j represents an index of an individual in the initial population, and j∈[1, d], d represents a number of individuals in the initial population; and Qⱼ={T_{αj}, R_{βj}, C_{γj}, H_{ρj}}; where T_{αj}, R_{βj}, C_{γj}, and H_{ρj} represent a material type of cutter, a form type of cutting edge, a material type of coating, and a thickness of coating of the j-th individual, respectively.

The data-processing module is configured for processing the cutter characteristic data to obtain a life-evaluation coefficient for evaluating life of a cutter; and processing the workpiece cutting performance data to obtain a quality-evaluation coefficient for evaluating quality of a workpiece; and linearly processing the life-evaluation coefficient and the quality-evaluation coefficient to obtain a comprehensive evaluation coefficient.

Based on the above embodiment, the cutter characteristic data is processed based on following formula to obtain the life-evaluation coefficient for evaluating life of the cutter:

$${SPxs}_{j} = {w}_{1} {Vb}_{j} + {w}_{2} Δ {F}_{j} ;$$

where SPxsⱼ represents a life-evaluation coefficient of the j-th individual, and the life-evaluation coefficient is used to comprehensively evaluate a length of life of the cutter by combining two indicators of the wear width of rear cutting edge and the increase in cutting force. The smaller the life-evaluation coefficient is, meaning that the longer the life of cutter is.

And Vbⱼ represents the wear width of rear cutting edge of the j-th individual; ΔFⱼ represents the increase in cutting force of the j-th individual.

On the basis of this, it should be noted that an increase in the wear width of rear cutting edge Vbⱼ means that the friction between the rear cutting edge of cutter and the workpiece surface intensifies, the degree of cutter wear increases, the sharpness of the cutting edge decreases, the energy consumption during the cutting process increases, resulting in an increase in cutting force, a decrease in machining accuracy, and a reduction in the time for the cutter to continue working normally, thus reducing the life of cutter. The increase in cutting force ΔFⱼ increases, meaning that the load borne by the cutter during the cutting process increases, which accelerates cutter wear and makes the cutter more prone to failure forms such as breakage and chipping, thereby shortening the service life of cutter. Therefore, the above weighted sum formula is used to characterize the functional relationship between the life-evaluation coefficient SPxsⱼ, the wear width of rear cutting edge Vbⱼ and the increase in cutting force ΔFⱼ.

In the formula, w₁ represents a weight coefficient of the wear width of rear cutting edge, and w₂ represents a weight coefficient of the increase in cutting force.

Due to the fact that the wear width of rear cutting edge is a direct reflection of cutter wear and has a more direct and close relationship with cutter life, as the wear width of rear cutting edge increases, the shape and size of the cutting edge of the cutter will change, directly affecting cutting performance, leading to problems such as decreased machining accuracy and poor surface quality. In severe cases, the cutter may lose its cutting ability.

In most cutting processes, the variation of the wear width of rear cutting edge is relatively stable and regular, and is easier to be predicted and evaluated through experiments and experience. In contrast, the increase in cutting force is influenced by various factors, such as the non-uniformity of the workpiece material, small fluctuations in cutting parameters, and vibration of the machining system, and the variation of the increase in cutting force may be more complex and unstable. Therefore, when the life of cutter is evaluated, the reliability of the wear width of rear cutting edge is higher, and a greater weight is given to the wear width of rear cutting edge can more accurately reflect the actual situation of life of cutter.

Therefore, when w₁+w₂=1 is met, 0<w₂<w₁<1.

As a specific embodiment, the value range of w₁ is 0.5-1, and the value range of w₂ is 0-0.5. The specific values are set by technical personnel according to the actual situation and are not limited here.

Based on the above embodiment, the cutting performance data is processed based on following formula to obtain the quality-evaluation coefficient for evaluating quality of the workpiece:

$${QPxs}_{j} = {w}_{3} {Ra}_{j} + {w}_{4} {σ}_{j} ;$$

where QPxsⱼ represents a quality-evaluation coefficient of the j-th individual, and the quality-evaluation coefficient is used to comprehensively evaluate a quality of the workpiece by combining two indicators of the surface roughness and the residual stress of the workpiece. The smaller the quality-evaluation coefficient is, the better the quality of workpiece is.

Raⱼ represents the surface roughness of the workpiece of the j-th individual; and σⱼ represents the residual stress of the j-th individual.

On the basis of this, it should be noted that an increase in the surface roughness of the workpiece Ra; means that the degree of fluctuation of the workpiece surface on the microscopic level increases, which will have a negative impact on multiple properties of the workpiece. An increase in surface roughness will lead to a decrease in fitting accuracy and affect the overall stability of the equipment. In terms of corrosion resistance, rough surfaces are more likely to accumulate corrosive substances, accelerating the corrosion process of workpiece, and thereby reducing the service life of workpiece, resulting in a decrease in workpiece quality. An increase in residual stress σⱼ can lead to an unstable stress state inside the workpiece. When the workpiece is subjected to external loads, the residual stress overlaps with the external loads, causing local stress to exceed the yield strength of the material, resulting in deformation or even cracking of the workpiece. Especially under alternating loads, residual stress can significantly reduce the fatigue life of workpiece and lead to a decrease in workpiece quality. Therefore, the weighted sum formula mentioned above is used to characterize the functional relationship among the quality-evaluation coefficient QPxsⱼ, the surface roughness of workpiece Raⱼ, and the residual stress σⱼ.

In the formula, w₃ represents a weight coefficient of the surface roughness of workpiece, and w₄ represents a weight coefficient of the residual stress.

Relatively speaking, machining processes may be easier to control the residual stress, or can effectively adjust and optimize the residual stress during the machining process, so that the impact of the residual stress on workpiece quality is relatively small. However, the surface roughness may be difficult to achieve ideal accuracy due to limitations in machining processes, and fluctuations of the surface roughness have a significant impact on workpiece quality. For example, in some precision grinding processes, although residual stress can be controlled by adjusting process parameters, the surface roughness is greatly affected by factors such as grain size of emery cutter and grinding parameters, and is difficult to be accurately controlled. In this case, it is necessary to increase the weight of surface roughness w₃.

Therefore, when w₃+w₄=1 is met, 0<w₄<w₃<1.

As a specific embodiment, the value range of w₃ is 0.5-1, and the value range of w₄ is 0-0.5. The specific values are set by technical personnel according to the actual situation and are not limited here.

Based on the above embodiment, the life-evaluation coefficient and the quality-evaluation coefficient are linearly processed based on following formula to obtain the comprehensive evaluation coefficient:

$${ZPxs}_{j} = {w}_{5} {SPxs}_{j} + {w}_{6} {QPxs}_{j} ;$$

where ZPxsⱼ represents a comprehensive evaluation coefficient of the j-th individual, and the comprehensive evaluation coefficient is used to comprehensively evaluate an overall performance of the combination of cutter and coating by combining two indicators of the life-evaluation coefficient and the quality-evaluation coefficient. The smaller the comprehensive evaluation coefficient is, meaning that the better the overall performance of the combination of cutter and coating is while ensuring the workpiece quality, and the longer the life of cutter is.

On the basis of this, it should be noted that a decrease in the life-evaluation coefficient SPxsⱼ means that the life of cutter is relatively extended, and the cutter wear slows down during the cutting process, and the wear width of rear cutting edge decreases, and the increase in cutting force also decreases accordingly, allowing the cutter to perform cutting more stably. While meeting the processing requirements, the cost of frequent replacement of cutter and the impact on processing efficiency can be reduced, and the overall performance of the combination of cutter and coating can be improved. A decrease in the quality-evaluation coefficient QPxsⱼ indicates that the workpiece quality is better, the surface roughness of workpiece is reduced, and the degree of fluctuation on the microscopic level is reduced, which is beneficial for improving the fitting accuracy of workpiece and enhancing the overall operational stability of the equipment. And the reduction of residual stress keeps the workpiece in a more stable stress state, making the workpiece less prone to deformation or cracking when subjected to external loads, significantly improving the service life and reliability of workpiece, and enhancing the overall performance of the combination of cutter and coating. Therefore, the above weighted sum formula is used to characterize the functional relationship among the comprehensive evaluation coefficient ZPxsⱼ, the life-evaluation coefficient SPxsⱼ, and the quality-evaluation coefficient QPxsⱼ.

In the formula, w₅ represents a weight coefficient of the life-evaluation coefficient, and w₆ represents a weight coefficient of the quality-evaluation coefficient; and values of w₅ and w₆ are determined by an analytic hierarchy process. The specific logic is as follows:

The two indicators of life-evaluation coefficient and quality-evaluation coefficient are marked, the relative importance values between each pair are determined through the nine-scale method, and a judgment matrix is established. Where the index of the life-evaluation coefficient is marked as 1 and the index of the quality-evaluation coefficient is marked as 2. The established judgment matrix is expressed as:

$${[ {q}_{uv} ]}_{2 \times 2} = [ \begin{matrix}{q}_{11} , {q}_{12} \\ {q}_{21} , {q}_{22}\end{matrix} ] ;$$

where u and v represent the index of the coefficients respectively, and u∈[1, 2] and v∈[1, 2], which represent the importance of the coefficient with index u to the comprehensive evaluation coefficient relative to the coefficient with index v. The specific value of qᵤᵥ is determined by relevant experts using a 1-9 scoring method. qᵤᵥ=9 means that coefficient with index u is extremely important to the comprehensive evaluation coefficient relative to the coefficient with index v, while qᵤᵥ=1 means that the coefficient with index u is extremely unimportant to the comprehensive evaluation coefficient relative to the coefficient with index v.

The value of each element in the judgment matrix is divided by the total number of columns of the judgment matrix to obtain a normalized judgment matrix. The mean value of all elements in each row of the normalized judgment matrix is calculated, and the mean value of all elements in the first row of the normalized judgment matrix is served as the proportion coefficient of the life-evaluation coefficient, and the mean value of all elements in the second row of the normalized judgment matrix is served as the proportion coefficient of the quality-evaluation coefficient. With the constraint that the sum of the scaled values is equal to 1, the proportional scaling is performed on the two proportion coefficients, and the scaled values are served as the weight of the life-evaluation coefficient and the weight of the quality-evaluation coefficient, respectively.

The iterative optimization module is configured for iteratively optimizing the individuals in the initial population through a genetic algorithm based on minimization of the comprehensive evaluation coefficient, to obtain optimal individuals; and extracting an optimal value of the cutter parameters and an optimal value of the coating parameters based on the optimal individuals.

Based on the above embodiment, the iterative optimization module relates to following specific processes:

A minimization of the comprehensive evaluation coefficient ZPxsⱼ is served as an optimization objective, and the initial population Q is iteratively optimized. That is, individuals in the initial population Q are selected and cross-operation is performed on the selected individuals. During the iteratively optimizing, constraint conditions including a maximum value and a minimum value of the thickness of coating are preset. And within a constraint range of the thickness of coating, the initial population Q is iteratively optimized, including: sorting all comprehensive evaluation coefficients ZPxsⱼ corresponding to the individuals in an ascending order to obtain a sequence, selecting individuals corresponding to a top 50% of the sequence as parents, exchanging genes of individuals in the parents through the cross-operation and combining to obtain new individuals, and repeating the process of selecting and the cross-operation until a predetermined number of iterations is reached.

After iteratively optimizing the initial population Q serving the optimal individuals as Qⱼ₁={T_{α1j1}, R_{β1j1}, C_{γ1j1}, H_{ρ1j1}}; and the optimal value of the cutter parameters and the optimal value of the coating parameters include: a material type of cutter T_{α1j1}, a form type of cutting edge R_{β1j1}, a material type of coating C_{γ1j1}, and a thickness of coating H_{ρ1j1}, respectively.

The recommendation module is configured for selecting an optimal combination of a cutter with an optimal value and a coating with an optimal value and recommending to a user.

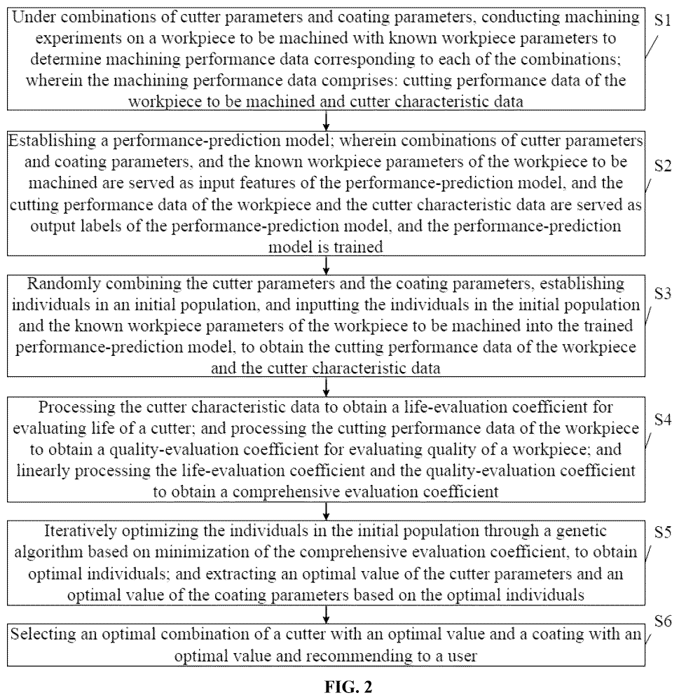

Please refer to FIG. 2, the present disclosure also provides following technical solution:

A recommendation method for cutting and coating combination based on workpiece parameters is also provided, which is generated based on the above recommendation system, and the recommendation method includes following steps S1 to S6.

In step S1, under combinations of cutter parameters and coating parameters, machining experiments are conducted on a workpiece to be machined with known workpiece parameters to determine machining performance data corresponding to each of the combinations. The machining performance data includes: workpiece cutting performance data to be processed and cutter characteristic data.

In step S2, a performance-prediction model is established. Combinations of cutter parameters and coating parameters, and the known workpiece parameters of the workpiece to be machined are served as input features of the performance-prediction model, and the workpiece cutting performance data and the cutter characteristic data are served as output labels of the performance-prediction model, and the performance-prediction model is trained.

In step S3, the cutter parameters and the coating parameters are randomly combined, individuals in an initial population are established, and the individuals in the initial population and the known workpiece parameters of the workpiece to be machined are inputted into the trained performance-prediction model, to obtain the workpiece cutting performance data and the cutter characteristic data.

In step S4, the cutter characteristic data is processed to obtain a life-evaluation coefficient for evaluating life of a cutter; and the workpiece cutting performance data is processed to obtain a quality-evaluation coefficient for evaluating quality of a workpiece; and the life-evaluation coefficient and the quality-evaluation coefficient are linearly processed to obtain a comprehensive evaluation coefficient.

In step S5, the individuals in the initial population are iteratively optimized through a genetic algorithm based on minimization of the comprehensive evaluation coefficient, to obtain optimal individuals; and an optimal value of the cutter parameters and an optimal value of the coating parameters are extracted based on the optimal individuals.

In step S6, an optimal combination of a cutter with an optimal value and a coating with an optimal value is selected and recommended to a user.

The above formulas are all dimensionless and numerically calculated. The formulas are obtained by collecting a large amount of data and simulating the latest real situation through software. The preset parameters in the formulas are set by those skilled in the art according to the actual situation.

The above embodiments can be fully or partially implemented through software, hardware, firmware, or any other combination. When implemented using software, the above embodiments can be fully or partially implemented in the form of a computer program product. Those skilled in the art can realize that the units and algorithm steps described in the embodiments according to the present disclosure can be implemented using electronic hardware, or a combination of computer software and electronic hardware. Whether these functions are executed through hardware or software methods depends on the specific application and design constraints of the technical solution.

The units described as separate components may or may not be physically separated, and the components displayed as units may or may not be physical units, either located in one place or distributed across multiple network units. Some or all of the units can be selected according to actual needs to achieve the purpose of the embodiments according to the present disclosure.

The above is only specific embodiments of the present disclosure, but the scope of protection of the present disclosure is not limited to them. Any skilled person familiar with the technical field can easily think of changes or substitutions within the technical scope disclosed in the present disclosure, which should be included in the scope of protection of the present disclosure.

What is claimed is:

1. A recommendation system for matching cutter and coating combinations based on workpiece parameters, comprising:
an experimental module, configured for, under different combinations of cutter parameters and coating parameters, conducting machining experiments on a workpiece to be machined with known workpiece parameters to determine machining performance data corresponding to each of the different combinations; wherein the machining performance data comprises: workpiece cutting performance data and cutter characteristic data;
a prediction-model-establishment module, configured for establishing a performance-prediction model; wherein combinations of cutter parameters and coating parameters, and the known workpiece parameters of the workpiece to be machined are served as input features of the performance-prediction model, and the workpiece cutting performance data and the cutter characteristic data are served as output labels of the performance-prediction model, and the performance-prediction model is trained;
a simulation module, configured for randomly combining the cutter parameters and the coating parameters, establishing individuals in an initial population, and inputting the individuals in the initial population and the known workpiece parameters of the workpiece to be machined into the trained performance-prediction model, to obtain the workpiece cutting performance data and the cutter characteristic data;
a data-processing module, configured for processing the cutter characteristic data to obtain a life-evaluation coefficient for evaluating life of a cutter; and processing the workpiece cutting performance data to obtain a quality-evaluation coefficient for evaluating quality of a workpiece; and linearly processing the life-evaluation coefficient and the quality-evaluation coefficient to obtain a comprehensive evaluation coefficient;
an iterative optimization module, configured for iteratively optimizing the individuals in the initial population through a genetic algorithm based on minimization of the comprehensive evaluation coefficient, to obtain optimal individuals; and configured for extracting an optimal value of the cutter parameters and an optimal value of the coating parameters based on the optimal individuals; and
a recommendation module, configured for selecting an optimal combination of a cutter with an optimal value and a coating with an optimal value and recommending to a user.

2. The recommendation system according to claim 1, wherein the known workpiece parameters comprise a material type of workpiece, wherein the material type of workpiece comprises: mild steel, medium carbon steel, high carbon steel, stainless steel, aluminum alloy, copper alloy, titanium alloy, nickel-based alloy, plastic, ceramic, and composites; and the cutter parameters comprise: a material type of cutter and a form type of cutting edge; wherein the material type of cutter comprises: high-speed steel, cemented carbide, ceramic material, cubic boron nitride, and polycrystalline diamond; and the form type of cutting edge comprises: straight edge, arc-shaped edge, cutting edge with negative chamber, tooth-shaped edge, and cutting edge with micro rounded corner; and the coating parameters comprise: a material type of coating and a thickness of coating; wherein the material type of of coating comprises: titanium nitride, titanium carbonitride, aluminum titanium nitride, chromium nitride, and diamond coating.

3. The recommendation system according to claim 1, wherein the cutter characteristic data comprises: a wear width of a rear cutting edge and an increase in cutting force; and wherein the workpiece cutting performance data comprises: surface roughness and residual stress of the workpiece.

4. The recommendation system according to claim 2, wherein a material set W of the workpiece is defined, wherein W={Wᵢ|i∈[1, n]}; and Wᵢ represents a material type of an i-th type of workpiece, i represents an index of the material type of workpiece, and n represents a number of material types of workpiece;
wherein a process of randomly combining the cutter parameters and the coating parameters, and establishing individuals in the initial population comprises:
defining a material set of cutter as T, wherein T={T_{α}|α∈[1, m]}; T_{α} represents a material type of an α-th type of cutter, α represents an index of the material type of cutter, and m represents a number of material types of cutter;
defining a form set of cutting edge as R, wherein R={R_{β}|β∈[1, r]}; R_{β} represents a form of β-th type of cutting edge, β represents an index of the form of cutting edge, and r represents a number of forms of cutting edge;
defining a material set of coating as C, wherein C={C_{γ}|γ∈[1, k]}; C_{γ} represents a material type of a γ-th type of coating, γ represents an index of the material type of coating, and k represents a number of material types of coating;
defining a thickness set of coating as H, wherein H={H_{ρ}|ρ∈[1, g]}; H_{ρ} represents a thickness of a ρ-th type of coating, ρ represents an index of the thickness of coating, and g represents a number of thicknesses of coating;
defining the initial population as Q, and wherein Q={Q₁, Q₂, . . . , Qⱼ . . . , Qₙ}; Qⱼ represents a j-th individual in the initial population, j represents an index of an individual in the initial population, and j∈[1, d], d represents a number of individuals in the initial population; and Qⱼ={T_{αj}, R_{βj}, C_{γj}, H_{ρj}}; wherein T_{αj}, R_{βj}, C_{γj}, and H_{ρj} represent a material type of cutter, a form type of cutting edge, a material type of coating, and a thickness of coating of the j-th individual, respectively.

5. The recommendation system according to claim 3, wherein the cutter characteristic data is processed based on following formula to obtain the life-evaluation coefficient for evaluating life of the cutter:
$${SPxs}_{j} = {w}_{1} {Vb}_{j} + {w}_{2} Δ {F}_{j} ;$$
wherein SPxsⱼ represents a life-evaluation coefficient of the j-th individual, and the life-evaluation coefficient is used to comprehensively evaluate a length of life of the cutter by combining two indicators of the wear width of rear cutting edge and the increase in cutting force; Vbⱼ represents the wear width of rear cutting edge of the j-th individual; ΔFⱼ represents the increase in cutting force of the j-th individual; and j represents the index of the individual in the initial population;
and wherein w₁ represents a weight coefficient of the wear width of rear cutting edge, and w₂ represents a weight coefficient of the increase in cutting force; and wherein when w₁+w₂=1 is met, 0<w₂<w₁<1.

6. The recommendation system according to claim 5, wherein the cutting performance data is processed based on following formula to obtain the quality-evaluation coefficient for evaluating quality of the workpiece:
$${QPxs}_{j} = {w}_{3} {Ra}_{j} + {w}_{4} {σ}_{j} ;$$
wherein QPxsⱼ represents a quality-evaluation coefficient of the j-th individual, and the quality-evaluation coefficient is used to comprehensively evaluate a quality of the workpiece by combining two indicators of the surface roughness and the residual stress of the workpiece; Raⱼ represents the surface roughness of the workpiece of the j-th individual; and σⱼ represents the residual stress of the j-th individual;
and wherein w₃ represents a weight coefficient of the surface roughness of workpiece, and w₄ represents a weight coefficient of the residual stress; and wherein, when w₃+w₄=1 is met, 0<w₄<w₃<1.

7. The recommendation system according to claim 6, wherein the life-evaluation coefficient and the quality-evaluation coefficient are processed based on following formula to obtain the comprehensive evaluation coefficient:
$${ZPxs}_{j} = {w}_{5} {SPxs}_{j} + {w}_{6} {QPxs}_{j} ;$$
wherein ZPxsⱼ represents a comprehensive evaluation coefficient of the j-th individual, and the comprehensive evaluation coefficient is used to comprehensively evaluate an overall performance of the combination of cutter and coating by combining two indicators of the life-evaluation coefficient and the quality-evaluation coefficient;
and wherein w₅ represents a weight coefficient of the life-evaluation coefficient, and w₆ represents a weight coefficient of the quality-evaluation coefficient; and values of w₅ and w₆ are determined by an analytic hierarchy process.

8. The recommendation system according to claim 7, wherein the iteratively optimizing the individuals in the initial population through a genetic algorithm based on minimization of the comprehensive evaluation coefficient, to obtain optimal individuals; and extracting an optimal value of the cutter parameters and an optimal value of the coating parameters based on the optimal individuals comprise:
serving a minimization of the comprehensive evaluation coefficient ZPxsⱼ as an optimization objective, and iteratively optimizing the initial population Q, which comprises: selecting individuals in the initial population Q and performing cross-operation on the selected individuals; wherein during the iteratively optimizing, constraint conditions comprising a maximum value and a minimum value of the thickness of coating are preset; and within a constraint range of the thickness of coating, iteratively optimizing the initial population Q wherein iteratively optimizing the initial population Q comprises: sorting all comprehensive evaluation coefficients ZPxsⱼ corresponding to the individuals in an ascending order to obtain a sequence, selecting individuals corresponding to a top 50% of the sequence as parents, exchanging genes of individuals in the parents through the cross-operation and combining to obtain new individuals, and repeating a process of selecting individuals corresponding to a top 50% of the sequence as parents, exchanging genes of individuals in the parents through the cross-operation and combining to obtain new individuals, until a predetermined number of iterations is reached;
after iteratively optimizing the initial population Q, serving the optimal individuals as Qⱼ₁={T_{α1j1}, R_{β1j1}, C_{γ1j1}, H_{ρ1j1}}; wherein the optimal value of the cutter parameters and the optimal value of the coating parameters comprise: a material type of cutter T_{α1j1}, a form type of cutting edge R_{β1j1}, a material type of coating C_{γ1j1}, and a thickness of coating H_{ρ1j1}, respectively.

9. A recommendation method for cutting and coating combination based on workpiece parameters, which is generated based on the recommendation system according to claim 1, comprising:
step S1: under combinations of cutter parameters and coating parameters, conducting machining experiments on a workpiece to be machined with known workpiece parameters to determine machining performance data corresponding to each of the combinations; wherein the machining performance data comprises workpiece cutting performance data and cutter characteristic data;
step S2: establishing a performance-prediction model; wherein combinations of cutter parameters and coating parameters, and the known workpiece parameters of the workpiece to be machined are served as input features of the performance-prediction model, and the workpiece cutting performance data and the cutter characteristic data are served as output labels of the performance-prediction model, and wherein the performance-prediction model is trained;
step S3: randomly combining the cutter parameters and the coating parameters, establishing individuals in an initial population, and inputting the individuals in the initial population and the known workpiece parameters of the workpiece to be machined into the trained performance-prediction model, to obtain the workpiece cutting performance data and the cutter characteristic data;
step S4: processing the cutter characteristic data to obtain a life-evaluation coefficient for evaluating life of a cutter; and processing the workpiece cutting performance data to obtain a quality-evaluation coefficient for evaluating quality of a workpiece; and linearly processing the life-evaluation coefficient and the quality-evaluation coefficient to obtain a comprehensive evaluation coefficient;
step S5: iteratively optimizing the individuals in the initial population through a genetic algorithm based on minimization of the comprehensive evaluation coefficient to obtain optimal individuals; and extracting an optimal value of the cutter parameters and an optimal value of the coating parameters based on the optimal individuals; and
step S6: selecting an optimal combination of a cutter with an optimal value and a coating with an optimal value and recommending to a user.

10. The recommendation method according to claim 9, wherein the known workpiece parameters comprise a material type of workpiece, which comprises: mild steel, medium carbon steel, high carbon steel, stainless steel, aluminum alloy, copper alloy, titanium alloy, nickel-based alloy, plastic, ceramic, and composites; and the cutter parameters comprise: a material type of cutter and a form type of cutting edge; the material type of cutter comprises: high-speed steel, cemented carbide, ceramic material, cubic boron nitride, and polycrystalline diamond; and the form type of cutting edge comprises: straight edge, arc-shaped edge, cutting edge with negative chamber, tooth-shaped edge, and cutting edge with micro rounded corner; and the coating parameters comprise: a material type of coating and a thickness of coating; wherein the material type of coating comprises: titanium nitride, titanium carbonitride, aluminum titanium nitride, chromium nitride, and diamond coating.

11. The recommendation method according to claim 9, wherein the cutter characteristic data comprises: a wear width of rear cutting edge and in increase in cutting force; and the workpiece cutting performance data comprises: surface roughness and residual stress of the workpiece.

12. The recommendation method according to claim 10, wherein a material set W of the workpiece is defined, wherein W={Wᵢ|i∈[1, n]}; and Wᵢ represents a material type of an i-th type of workpiece, i represents an index of the material type of workpiece, and n represents a number of material types of workpiece;
wherein a process of randomly combining the cutter parameters and the coating parameters, and establishing individuals in the initial population comprises:
defining a material set of cutter as T, wherein T={T_{α}|α∈[1, m]}; T_{α} represents a material type of an α-th type of cutter, α represents an index of the material type of cutter, and m represents a number of material types of cutter;
defining a form set of cutting edge as R, wherein R={R_{β}|β∈[1, r]}; R_{β} represents a form of a β-th type of cutting edge, β represents an index of the form of cutting edge, and r represents a number of forms of cutting edge;
defining a material set of coating as C, wherein C={C_{γ}|γ∈[1, k]}; C_{γ} represents a material type of a γ-th type of coating, γ represents an index of the material type of coating, and k represents a number of material types of coating;
defining a thickness set of coating as H, wherein H={H_{ρ}|ρ∈[1, g]}; H_{ρ} represents a thickness of a ρ-th type of coating, ρ represents an index of the thickness of coating, and g represents a number of thicknesses of coating;
defining the initial population as Q, and wherein Q={Q₁, Q₂, . . . , Qⱼ, . . . , Qₙ}; Qⱼ represents a j-th individual in the initial population, j represents an index of an individual in the initial population, and j∈[1, d], d represents a number of individuals in the initial population; and Qⱼ={T_{αj}, R_{βj}, C_{γj}, H_{ρj}}; wherein T_{αj}, R_{βj}, C_{γj}, and H_{ρj} represent a material type of cutter, a form type of cutting edge, a material type of coating, and a thickness of coating of the j-th individual, respectively.

13. The recommendation method according to claim 11, wherein the cutter characteristic data is processed based on following formula to obtain the life-evaluation coefficient for evaluating life of the cutter:
$${SPxs}_{j} = {w}_{1} {Vb}_{j} + {w}_{2} Δ {F}_{j} ;$$
wherein SPxsⱼ represents a life-evaluation coefficient of the j-th individual, and the life-evaluation coefficient is used to comprehensively evaluate a length of life of the cutter by combining two indicators of the wear width of rear cutting edge and the increase in cutting force; Vbⱼ represents the wear width of rear cutting edge of the j-th individual; ΔFⱼ represents the increase in cutting force of the j-th individual; and j represents the index of the individual in the initial population;
and wherein w₁ represents a weight coefficient of the wear width of rear cutting edge, and w₂ represents a weight coefficient of the increase in cutting force; and wherein when w₁+w₂=1 is met, 0<w₂<w₁<1.

14. The recommendation method according to claim 13, wherein the cutting performance data is processed based on following formula to obtain the quality-evaluation coefficient for evaluating quality of the workpiece:
$${QPxs}_{j} = {w}_{3} {Ra}_{j} + {w}_{4} {σ}_{j} ;$$
wherein QPxsⱼ represents a quality-evaluation coefficient of the j-th individual, and the quality-evaluation coefficient is used to comprehensively evaluate a quality of the workpiece by combining two indicators of the surface roughness and the residual stress of the workpiece; Raⱼ represents the surface roughness of the workpiece of the j-th individual; and σⱼ represents the residual stress of the j-th individual;
and wherein w₃ represents a weight coefficient of the surface roughness of workpiece, and w₄ represents a weight coefficient of the residual stress; and wherein when w₃+w₄=1 is met, 0<w₄<w₃<1.

15. The recommendation method according to claim 14, wherein the life-evaluation coefficient and the quality-evaluation coefficient are processed based on following formula to obtain the comprehensive evaluation coefficient:
$${ZPxs}_{j} = {w}_{5} {SPxs}_{j} + {w}_{6} {QPxs}_{j} ;$$
wherein ZPxsⱼ represents a comprehensive evaluation coefficient of the j-th individual, and the comprehensive evaluation coefficient is used to comprehensively evaluate an overall performance of the combination of cutter and coating by combining two indicators of the life-evaluation coefficient and the quality-evaluation coefficient;
and wherein w₅ represents a weight coefficient of the life-evaluation coefficient, and w₆ represents a weight coefficient of the quality-evaluation coefficient; and values of w₅ and w₆ are determined by an analytic hierarchy process.

16. The recommendation method according to claim 15, wherein the iteratively optimizing the individuals in the initial population through a genetic algorithm based on minimization of the comprehensive evaluation coefficient to obtain optimal individuals, and extracting an optimal value of the cutter parameters and an optimal value of the coating parameters based on the optimal individuals comprises:
serving a minimization of the comprehensive evaluation coefficient ZPxsⱼ as an optimization objective, and iteratively optimizing the initial population Q, which comprises: selecting individuals in the initial population Q and performing cross-operation on the selected individuals; wherein during the iteratively optimizing, constraint conditions comprising a maximum value and a minimum value of the thickness of coating are preset; and within a constraint range of the thickness of coating, iteratively optimizing the initial population Q, by sorting all comprehensive evaluation coefficients ZPxsⱼ corresponding to the individuals in an ascending order to obtain a sequence, selecting individuals corresponding to a top 50% of the sequence as parents, exchanging genes of individuals in the parents through the cross-operation and combining to obtain new individuals, and repeating a process of selecting individuals corresponding to a top 50% of the sequence as parents, exchanging genes of individuals in the parents through the cross-operation and combining to obtain new individuals, until a predetermined number of iterations is reached;
after iteratively optimizing the initial population Q, serving the optimal individuals as Qⱼ₁={T_{α1j1}, R_{β1j1}, C_{γ1j1}, H_{ρ1j1}}; wherein the optimal value of the cutter parameters and the optimal value of the coating parameters comprise: a material type of cutter T_{α1j1}, a form type of cutting edge R_{β1j1}, a material type of coating C_{γ1j1}, and a thickness of coating H_{ρ1j1}, respectively.
